(19) United States
(12) Patent Application Publication
(10) Pub. No.: US 2024/0348018 A1
(43) Pub. Date: Oct. 17, 2024

(54) SYSTEM FOR ELECTRICALLY ISOLATING A BUS BAR IN A BUS BAR VAULT

(71) Applicant: Consolidated Edison Company of New York, Inc., New York, NY (US)

(72) Inventors: Matthew DeLiso, Brooklyn, NY (US); Matthew Seiling, Westbury, NY (US)

(21) Appl. No.: 18/301,496

(22) Filed: Apr. 17, 2023

(51) Int. Cl. H02B 1/20; H02B 1/38

(52) U.S. Cl. CPC H02B 1/20; H02B 1/38

(57) ABSTRACT

A system for electrically isolating a live electrical busbar includes a housing made from a dielectric material. The housing has a first wall, a second wall extending from the first wall, and a third wall extending from the second wall. The first wall, second wall and third wall cooperate to define a hollow interior portion sized to receive the electrical busbar. A door member is rotationally coupled on a first end to the third wall. A fastener is operable to releasably couple a second end of the door member to an end of the first wall.

### BACKGROUND

The subject matter disclosed herein relates to a system and method of isolating electrical conductors, and in particular to a system and method of isolating busbar connections in a vault while service personnel are performing maintenance or repairs.

Busbars may include one or more solid metal conductors for supplying power to electrical devices. Conventional busbar systems use busbars with a rectangular cross-section for power transmission. The busbars may be mounted inside switch cabinets or in subterranean vaults. Busbars are used for single-phase or multi-phase power supply systems. For multi-phase power supply, busbars are conventionally arranged parallel to each other, with switching devices being arranged on the parallel busbars by means of latching elements or adapter devices.

It should be appreciated that when service personnel are performing service on busbars, such as in a vault, it is desirable to protect the personnel from electrical power flowing through the conductors. Using conventional procedures, the service personnel will place an electrically insulative sheet material, such as a rubber sheeting is placed over or wrapped around live conductors.

Accordingly, while existing insulation systems are suitable for their intended purposes the need for improvement remains, particularly in providing a system and method of isolating busbars having the features described herein

### BRIEF DESCRIPTION

A system for electrically isolating a live electrical busbar, in accordance with a non-limiting example, includes a housing made from a dielectric material. The housing has a first wall, a second wall extending from the first wall, and a third wall extending from the second wall. The first wall, second wall and third wall cooperate to define a hollow interior portion sized to receive the electrical busbar. A door member is rotationally coupled on a first end to the third wall. A fastener is operable to releasably couple a second end of the door member to an end of the first wall.

In addition to one or more of the features described herein, or as an alternative, further embodiments of the system may include a fourth wall extending from the end of the first wall, the fourth wall being perpendicular to the first wall.

In addition to one or more of the features described herein, or as an alternative, further embodiments of the system may include a hinge having a first portion coupled to an outside surface of the third wall and a second portion coupled to a top surface of the door member.

In addition to one or more of the features described herein, or as an alternative, further embodiments of the system may include the hinge is a piano hinge made from a first plastic material.

In addition to one or more of the features described herein, or as an alternative, further embodiments of the system may include the first portion of the hinge is coupled to the third wall by another fastener made from a second plastic material.

In addition to one or more of the features described herein, or as an alternative, further embodiments of the system may include the another fastener is a hook and loop type fastener.

In addition to one or more of the features described herein, or as an alternative, further embodiments of the system may include the housing and the door member are made from a third plastic material.

In addition to one or more of the features described herein, or as an alternative, further embodiments of the system may include the third plastic material is a polycarbonate.

In addition to one or more of the features described herein, or as an alternative, further embodiments of the system may include the first wall, second wall, and third wall have substantially uniform wall thickness.

In addition to one or more of the features described herein, or as an alternative, further embodiments of the system may include the third wall has a length sized to position the door member substantially perpendicular to the first wall when the door member is in a closed position.

A method of electrically isolating a busbar, in accordance with a non-limiting example, includes providing an isolator system having a housing made from a dielectric material, the housing having a first wall, a second wall extending from the first wall, and a third wall extending from the second wall, the first wall, second wall and third wall cooperating to define a hollow interior portion sized to receive the electrical busbar, the isolator system further having a door member rotationally coupled on a first end to the third wall and a fastener operable to releasably couple a second end of the door member to an end of the first wall, uncoupling the door member from the first wall, rotating the door member to an open position to expose the interior portion, positioning the housing over the busbar, rotating the door member to a closed position, and coupling the door member to the first wall with the fastener.

In addition to one or more of the features described herein, or as an alternative, further embodiments of the method may include the electrical characteristic being a current level of electrical power flowing through the electrical conductor.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a schematic illustration of a utility electrical distribution system in accordance with an embodiment;

FIG. 2 is a side view illustration, partially in section, of a busbar vault in accordance with an embodiment;

FIG. 3A is a perspective view illustration of a busbar isolator in accordance with an embodiment; and

FIG. 3B is an end view illustration of the busbar isolator of FIG. 3A.

The detailed description explains embodiments of the disclosure, together with advantages and features, by way of example with reference to the drawings.

### DETAILED DESCRIPTION

Embodiments of the present disclosure provide for a system and method of isolating a busbar, such as in a busbar vault, to electrically isolate service or maintenance personnel from live conductors.

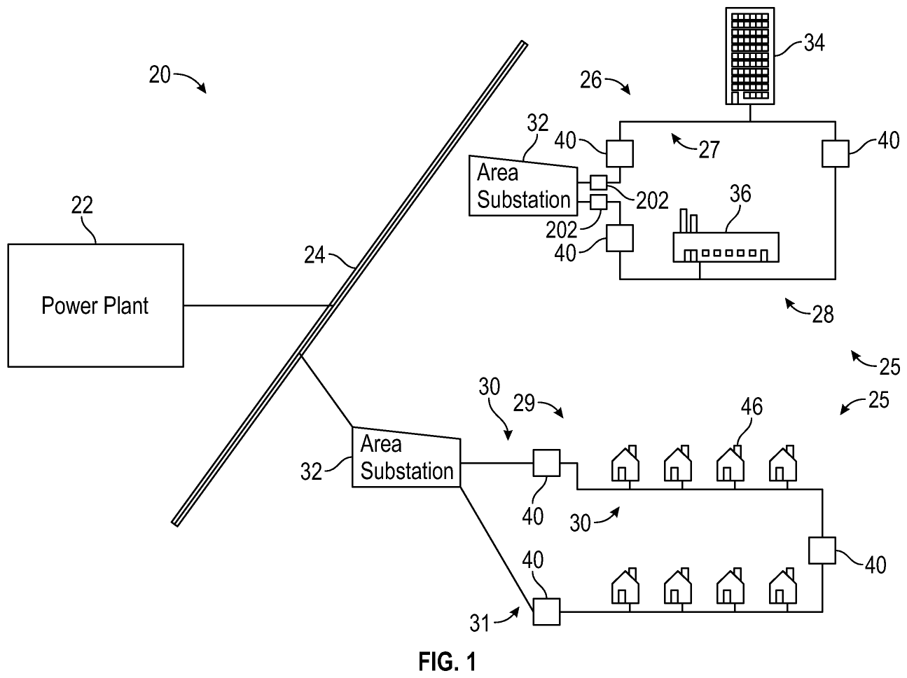

Referring now to FIG. 1, an embodiment is shown of a utility electrical distribution system 20. The utility electrical distribution system 20 includes one or more power sources 22 connected in parallel to a main transmission system 24. The one or more power sources 22 may include, but are not limited to: coal, nuclear, natural gas, or incineration power plants. Additionally, the one or more power sources 22 may include one or more facilities that generate electricity based on renewable energy sources, such as but not limited to hydroelectric, solar, or wind turbine power plants. It should be appreciated that additional components such as transformers, switchgear, fuses, and the like (not shown) may be incorporated into the utility electrical distribution system 20 as needed to ensure the efficient operation of the system. The utility electrical distribution system 20 is typically interconnected with one or more other utility networks to allow the transfer of electrical power into or out of the utility electrical distribution system 20.

The main transmission system 24 typically includes high transmission voltage power lines, anywhere from 69 KV to 500 KV for example, and associated transmission and distribution equipment which carry the electrical power from the point of production at the one or more power sources 22 to the end users located on local electrical distribution systems 25 including a commercial electrical distribution system 26 and a residential electrical distribution system 29. The local electrical distribution systems 25 are connected to the main distribution system by one or more area substations 32 which reduce transmission voltage to distribution levels such as 13 KV, 27 KV or 33 KV for example, sometimes referred to as medium voltage power lines. Area Substations 32 typically contain one or more transformers, switching, protection, and control equipment. Area Substations 32 also include circuit breakers that interrupt faults such as short circuits or over-load currents that may occur. Area substations 32 may further include equipment such as fuses, surge protection, controls, meters, capacitors, and load tap changers for voltage regulation.

The area substations 32 connect to one or more local electrical distribution systems 25, such as commercial electrical distribution system 26, for example, that provides electrical power to a commercial area having end users such as an office building 34 or a manufacturing facility 36. Local electrical distribution systems 25 In an embodiment, the area substations 32 may have two or more feeder circuits that provide electrical power to different feeder circuit branches 27, 28 of the commercial electrical distribution system 26. Feeder circuit branches 27 and 28 may include one or more distribution or step down transformers 40 that step down operating voltage from high voltage provided at substations 32 to operating voltage.

The residential electrical distribution system 29 includes one or more residential buildings 46 and light industrial or commercial operations. Similar to the commercial electrical distribution system 26, the residential electrical distribution system 29 is divided into multiple branch feeders 30, 31 that are fed by the area substations 32. In an embodiment, the residential electrical distribution system 29 is arranged such that approximately up to 6 MVA of power is provided on each branch circuit for electrical loads such as residential buildings. In a manner similar to that discussed herein, feeder circuit branches 30 and 31 may include one or more distribution or step down transformers 40 that step down operating voltage provided at substations 32 to operating voltage.

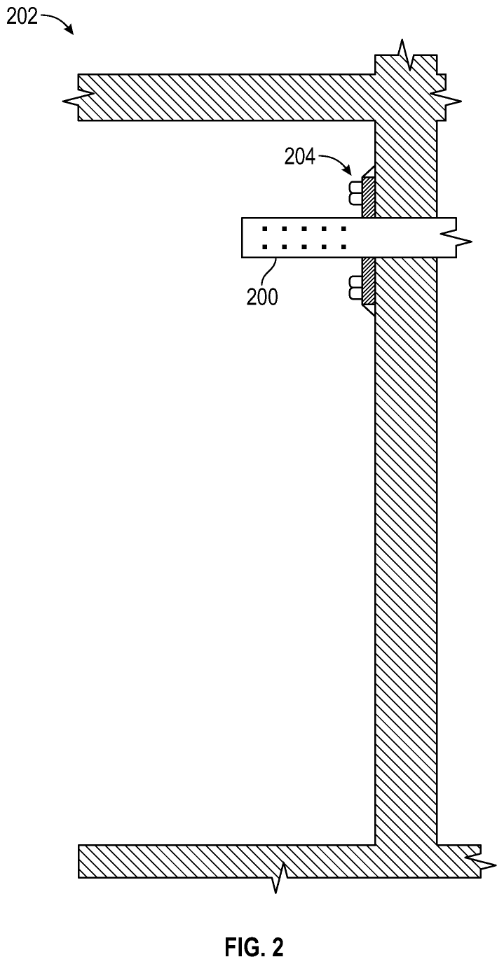

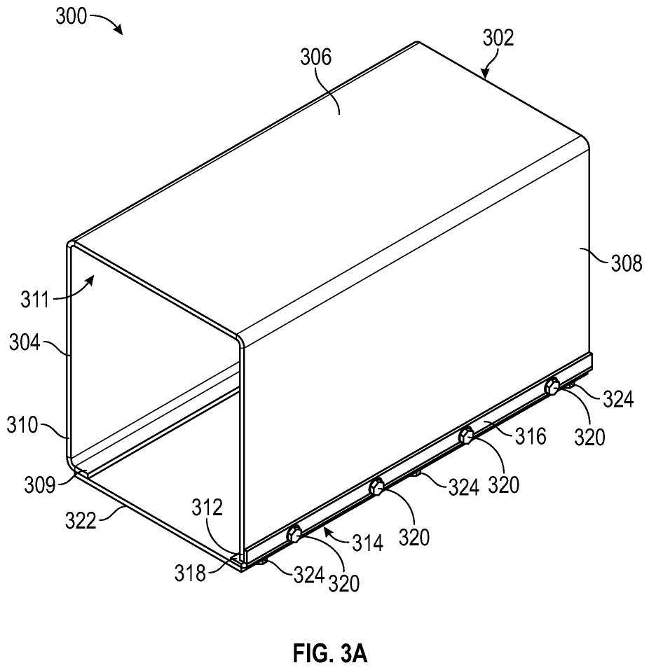

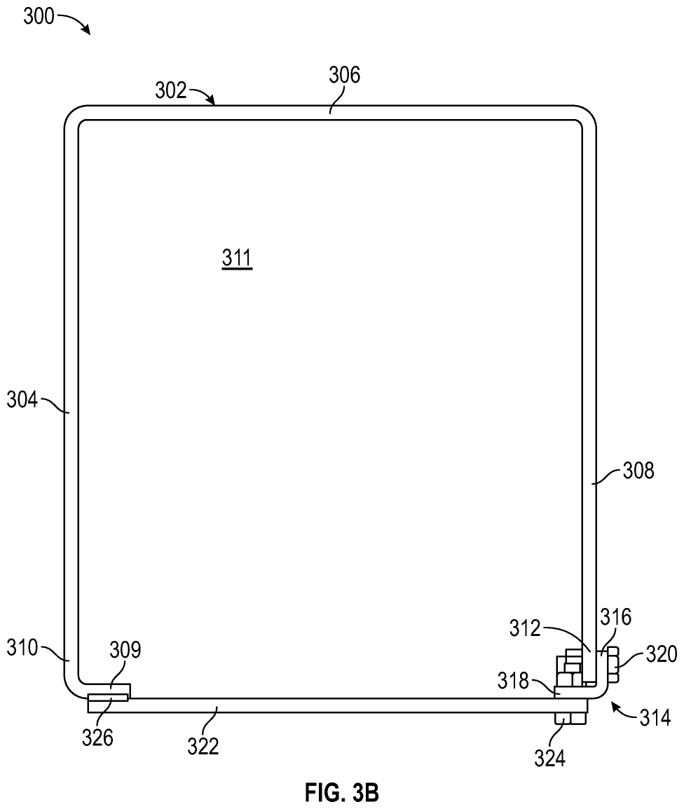

In some cases, the utility electrical distribution system 20 may use a type of conductor commonly referred to as a busbar 200. A busbar 200 is a metallic strip, bar, or rod, commonly made from brass, copper or aluminum, that is used to transfer high current or high voltage within a local area, such as a busbar vault 202 as is shown in FIG. 2. In the embodiment shown, busbar vault 202 is a subterranean structure, however, busbar vault 202 should not be understood to be limited to such subterranean installations. The busbar 200 is typically uninsulated and is supported in air by insulated pillars or connectors such as indicated at 204. This configuration allows for cooling of the conductors and the ability to electrically connect at different points along the busbar without creating a joint. It should be appreciated that while the uninsulated busbar is an efficient means of carrying current, the uninsulated nature of the busbar presents challenges to utility personnel when they are performing service in the busbar vault 202. To avoid inadvertent contact with the busbar 200, the utility personnel may install an insulator system 300 such as shown in FIGS. 3A and 3B on or about the busbar 200.

Referring now to FIG. 3A and FIG. 3B, an embodiment is shown of an insulator system 300. The insulator system 300 includes a housing 302 that includes a first wall 304, a second wall 306, and a third wall 308. In an embodiment, the second wall 306 is perpendicular to both the first wall 304 and the third wall 308. First, second, and third walls 304, 306, and 308 may be longer than the length of a side of the housing 302 to form a cuboid. In the illustrated embodiment, the first, second, and third walls 304, 306, and 308 have a uniform thickness. In one embodiment, a fourth wall 309 may project from an end 310 of the first wall 304. The housing 302 may be made from a material with suitable dielectric strength, such as but not limited to polycarbonate for example. The first, second, and third, walls 304, 306, and 308 define a hollow interior area 311 that is sized to receive the busbar 200. In the illustrated embodiment, the housing 302 has open ends. In an embodiment, the housing 302 is sized to cover the uninsulated portion of the busbar 200 when the service personnel are within the busbar vault.

Coupled to an end 312 of the third wall 308 is a rotational member 314. In an embodiment, the rotational member 314 is hinge, such as a piano hinge for example, that is comprised of a first portion 316 and a second portion 318. The first portion 316 is coupled to the third wall 308 by fasteners 320. The second portion 318 is coupled to a door member 322. In an embodiment, the door member 322 is made from an electrically insulative material, such as polycarbonate for example. The second portion 318 is coupled to the door member 322 by fasteners 324. In an embodiment, the rotational member 314 and the fasteners 320, 324 are made from an electrically insulative material, such as plastic, plastic composites, carbon fiber, and/or other non-electrically conducting materials for example.

In an embodiment, the door member 322 is coupled to the fourth wall 309 by a fastener 326 such as shown in FIG. 3B. In an embodiment, the fastener 326 may be a hook and loop style fastener.

In operation, the service personnel enter the busbar vault 202 and identify busbar 200 that may be within the area being serviced. The fastener 326 is decoupled, allowing the door member 322 to rotate about an axis defined by the rotational member 314. The rotating of the door member 322 from the closed position (FIG. 3A) to an open position exposes an open side of the housing 302 (e.g. the space between the end of the fourth wall 309 and the third wall 308). The open side and the hollow interior area 311 are sized to allow the insulator system 300 to be placed over the busbar 200. With door member 322 in the open position, the housing 302 is placed over the busbar 200. With the housing 302 enclosing the busbar 200, the service personnel rotate the door member 322 back to the closed position where it is held in place by the fastener 326. It should be appreciated that with the busbar disposed within the insulator system 300, the service personnel are electrically isolated from the busbar 200 and unintentional contact with the busbar 200 may be avoided.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions, or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A system for electrically isolating a live electrical busbar, the system comprising:
a housing made from a dielectric material, the housing having a first wall, a second wall extending from the first wall, and a third wall extending from the second wall, the first wall, second wall and third wall cooperating to define a hollow interior portion sized to receive the electrical busbar;
a door member rotationally coupled on a first end to the third wall;
a fastener operable to releasably couple a second end of the door member to an end of the first wall.

2. The system of claim 1, further comprising a fourth wall extending from the end of the first wall, the fourth wall being perpendicular to the first wall.

3. The system of claim 2, wherein the fastener comprises a hinge having a first portion coupled to an outside surface of the third wall and a second portion coupled to a top surface of the door member.

4. The system of claim 3, wherein the hinge is a piano hinge made from a first plastic material.

5. The system of claim 4, wherein the first portion of the hinge is coupled to the third wall by another fastener made from a second plastic material.

6. The system of claim 5, wherein the another fastener is a hook and loop type fastener.

7. The system of claim 6, wherein the housing and the door member are made from a third plastic material.

8. The system of claim 7, wherein the third plastic material is a polycarbonate.

9. The system of claim 8, wherein the first wall, second wall, and third wall have substantially uniform wall thickness.

10. The system of claim 9, wherein the third wall has a length sized to position the door member substantially perpendicular to the first wall when the door member is in a closed position.

11. A method of electrically isolating a busbar, the method comprising:
providing an isolator system having a housing made from a dielectric material, the housing having a first wall, a second wall extending from the first wall, and a third wall extending from the second wall, the first wall, second wall and third wall cooperating to define a hollow interior portion sized to receive the electrical busbar, the isolator system further having a door member rotationally coupled on a first end to the third wall and a fastener operable to releasably couple a second end of the door member to an end of the first wall;
uncoupling the door member from the first wall;
rotating the door member to an open position to expose the interior portion;
positioning the housing over the busbar;
rotating the door member to a closed position; and
coupling the door member to the first wall with the fastener.
